(19) United States
(12) Patent Application Publication
(10) Pub. No.: US 2005/0198854 A1
(43) Pub. Date: Sep. 15, 2005

(54) Hair conditioner applicator for use with a hair dryer

(76) Inventor: Robert Donald Hobe, Leesburg, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/075,893

(22) Filed: Mar. 10, 2005

Related U.S. Application Data
(60) Provisional application No. 60/551,998, filed on Mar. 10, 2004.

(51) Int. Cl. F26B 19/00; A45D 1/00

(52) U.S. Cl. 34/96; 34/60

(57) ABSTRACT

A hair conditioner applicator assembly is adapted to be mounted within an air stream of a hair dryer. The conditioner applicator assembly includes an assembly mounting structure for mounting the assembly relative to a portion of the hair dryer and a conditioner applicator element rotatably supported by the assembly mounting structure and constructed and arranged to rotate when exposed to the air stream of the hair dryer. Portions of a hair treatment product applied to the conditioner applicator element are deposited on the hair during air stream-induced rotation of the conditioner applicator element.

The present application claims priority from U.S. Provisional patent application Ser. No. 60/551,998, filed Mar. 10, 2004. The disclosure of the above-referenced provisional patent application is incorporated herein by reference in its entirety.

### BACKGROUND OF THE INVENTION

Electric, hot air hair dryers (also known as “blow dryers”) are used extensively in the home as well as in professional styling salons to dry and style hair. The hot air generated by such devices offers significant convenience in that it quickly dries wet hair. In addition, such devices, used in conjunction with a hair brush, facilitate hair styling and are used in numerous hair styling techniques intended to, for example, straighten hair or impart a curl, or wave, to the hair.

Along with the convenience and styling options offered by the hot air blow dryer, it is also well known that repeated exposure to hot air can damage hair. For example, studies have shown that continuous use of hair dryers, on a daily basis, causes cracking and damage to the hair cuticle due to the higher temperatures emitted from the hair dryer.

Various attempts have been made to incorporate into a hot air blow dryer devices to impart a moisturizing and/or scented substance onto the hair during operation of the hair dryer. Examples of such devices are described in U.S. Pat. Nos. 5,987,771; 5,761,824; 5,649,370; 4,597,191; and 5,572,800, and in U.S. Patent Publication No. 2003/0159306A1. In the devices described in the aforementioned publications, a fixed and stationary absorbent material is positioned within the interior air passageway of the hair dryer or an attachment to the hair dryer. The absorbent material is infused with a scent-emitting, moisturizing, or hydrating substance, and air-flow through or adjacent to the absorbent material causes microparticles of the substance to become entrained in the air flow and then deposited onto the hair.

### SUMMARY OF THE INVENTION

The invention described herein is an improvement over the devices described above. Disclosed herein is a conditioner applicator assembly adapted to be mounted within an air stream of a hair dryer. The conditioner applicator assembly includes an assembly mounting structure constructed and arranged for mounting the assembly relative to a portion of the hair dryer and a conditioner pad rotatably supported by the assembly mounting structure and constructed and arranged to rotate when exposed to the air stream of the hair dryer. A hair dryer incorporating the rotatable conditioner pad is also disclosed.

The conditioner pad is configured to receive a hair treatment product, which, in operation, is applied to the hair by the air stream of the hair dryer. The conditioner applicator assembly disclosed herein applies hair treatment product to the hair in a manner that provides several advantages over traditional means of applying hair treatment products, such as conditioners, that are applied in the shower or bath. Products applied in the shower or bath are frequently rinsed out of the hair, leaving only a small amount of product in the hair to provide a lasting treatment. A hair treatment product applied in the manner disclosed herein does not suffer this disadvantage. In addition, heat from a hair dryer causes the cuticle of the hair to open. A hair treatment product applied during the hair drying process will therefore be more readily received by the hair, making the treatment more effective. The more efficient treatment made possible by the conditioner applicator assembly disclosed herein is particularly beneficial to those who have fine or thin hair. Many of the most effective hair treatments are “leave-in” treatments, which are not preferable for those with fine or thin hair because they have a tendency to weigh the hair down. By improving the efficiency of the treatment with the conditioner applicator assembly disclosed herein, a smaller amount of product can be applied to the hair, providing the maximum treatment benefit without weighing the hair down.

In operation, the rotation of the conditioner pad in the air stream of the hair dryer serves several purposes which provide a number of advantages over prior art devices. The conditioner pad heats more evenly than a stationary pad would heat, thereby causing the hair treatment product to evaporate more evenly from the conditioner pad. In addition, because the conditioner pad heats more evenly, wear and tear on the conditioner pad is more evenly distributed, increasing the life of the conditioner pad. The conditioner pad does not absorb as much heat as a stationary pad would absorb, so the hair treatment product does not evaporate from the conditioner pad as rapidly, which increases the time that the hair dryer/conditioner applicator assembly can be operated before heat treatment product must be reapplied to the conditioner pad. Moreover, the risk of overheating the hair dryer is decreased, because the rotating conditioner pad does not restrict the air flow of the hair dryer as much as a stationary pad would. As a result, a larger diameter conditioner pad can be used than would be possible with a device utilizing a stationary pad, thereby increasing the amount of hair treatment product that can be applied to the conditioner pad.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of a primary embodiment of the conditioner applicator assembly.

FIG. 2 is a front plan of the conditioner pad of a primary embodiment.

FIG. 3 is a cross-section taken along line 3-3 in FIG. 2.

FIG. 4 is a perspective view of an alternate embodiment.

FIG. 5 is a perspective view of a single mounting ring.

FIG. 6 is a side elevation of the conditioner applicator assembly, including two mounting rings.

FIG. 7 is a cross-section view taken along line 7-7 in FIG. 6.

FIG. 8 is a rear perspective view of a conditioner applicator assembly installed into a hair dryer attachment.

FIG. 9 is a rear elevation of the assembly shown in FIG. 8.

FIG. 10 is a rear perspective view of a conditioner applicator assembly installed into a hair dryer attachment in an alternate embodiment.

FIG. 11 is a rear plan view of FIG. 10.

FIG. 12 is an exploded perspective view of an alternate embodiment.

FIG. 13 is a perspective view of an assembly mounting structure in an alternate embodiment.

FIG. 14 is a perspective view of the disassembled embodiment of FIG. 13.

### DETAILED DESCRIPTION OF THE EXEMPLARY EMBODIMENTS

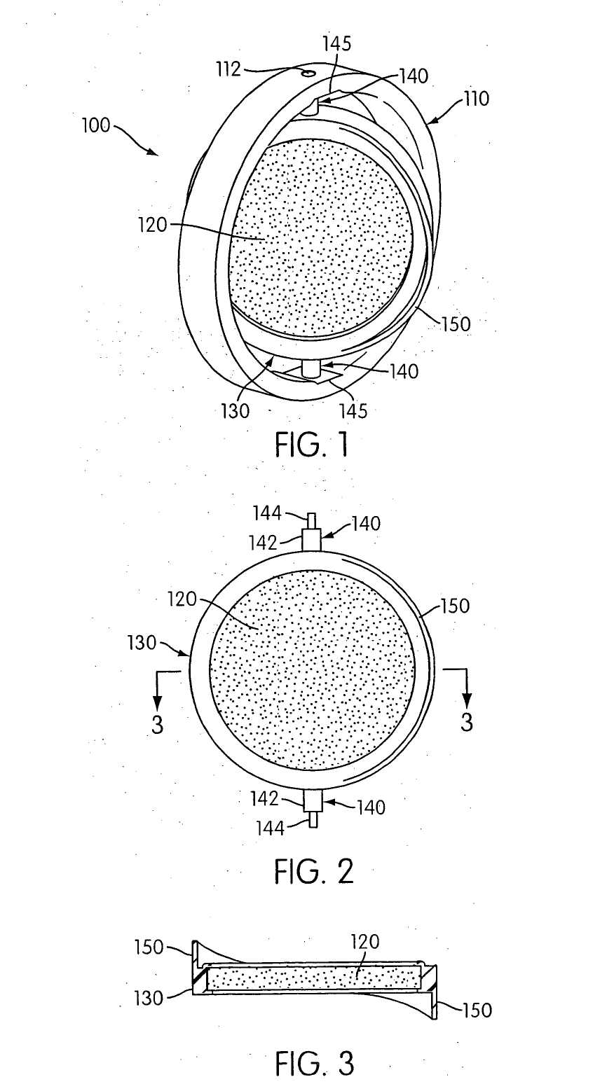

A first embodiment of a conditioner applicator assembly according to the present application is illustrated in FIG. 1. A conditioner applicator assembly 100 includes an assembly mounting structure, which, in the illustrated embodiment, comprises a mounting ring 110 and a rotatable conditioner applicator element, which, in the illustrated embodiment comprises disc-shaped conditioner pad 120 supported within surrounding inner ring 130. The assembly mounting structure (e.g., mounting ring 110) is constructed and arranged to be supported inside the air stream of a hair dryer, as will be described in more detail below. The conditioner pad 120 is rotatably mounted within the mounting ring 110, and the conditioner pad preferably rotates about an axis that is transverse to the direction of the air stream. The assembly mounting structure can be formed from any suitable rigid or semi-rigid material, including metal, ceramic, polybutylene terephthalate (PBT), acrylonitrile-butadiene-styrene copolymer (ABS), or other type of plastic.

The conditioner pad 120 is formed from an absorbent or semi-absorbent material. Non-exhaustive examples of suitable materials for the conditioner pad include: polyester, cotton, a blend of polyester or cotton, natural or synthetic sponge, wood, wood pulp, cellulose or ceramic. The conditioner pad 120 is configured to absorb a hair treatment product, such as a leave-in hair conditioner. One such hair conditioner is Therml Boost Treatment Spray, by Therml, Inc. In the context of the present invention, the term “hair conditioner” or “hair treatment” may comprise any substance that may be applied to the hair to affect the texture, moisture, scent, fullness, styling, or any other aspect of the hair, and, may include, for example, a conditioner, a fragrance, a fixative (e.g., liquid gel), or hydrating substance (e.g., water). The hair treatment product can be applied to the conditioner pad by a spray, or the conditioner pad can be dipped in the hair treatment product. The manner by which the hair treatment product is applied to the conditioner pad is not important, any method which transfers hair treatment product to the conditioner pad is acceptable.

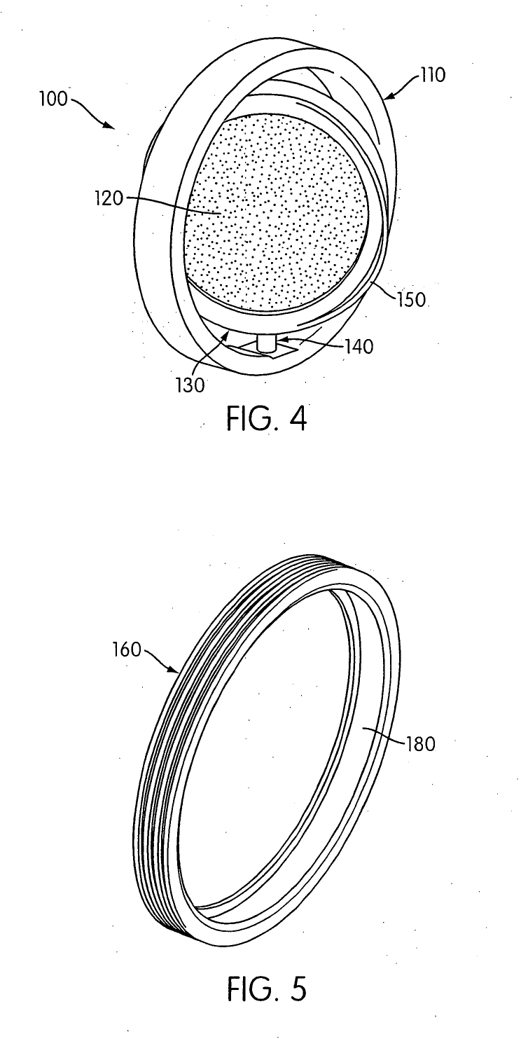

A preferred embodiment of the conditioner pad 120 is illustrated in FIGS. 2 and 3. The conditioner pad 120 is constructed and arranged to rotate when exposed to the air stream of a hair dryer.

The conditioner pad 120 is preferably supported within an inner ring 130. The inner ring 130 can be formed from any rigid or semi-rigid material, including metal, ceramic, polybutylene terephthalate (PBT), acrylonitrile-butadiene-styrene copolymer (ABS), or other type of plastic. The inner ring can be formed from the same type of material as is used for the mounting ring 110.

As shown in FIGS. 1 and 2, the inner ring 130 includes two diametrically opposed mounting prongs 140 that project radially outwardly from the inner ring 130 and cooperate with the mounting ring 110 to rotatably support the inner ring 130. Each prong 140 preferably has a larger diameter portion 142 on the end adjacent to the inner ring 130 and a smaller diameter portion 144 projecting from the larger diameter portion 142. The smaller diameter portion fits into a similarly sized hole 112 formed in the mounting ring 110. The difference in the diameters between portions 142 and 144 form an annular shoulder which bears against an inner surface of ring 130 when portion 144 of each prong 140 is inserted into corresponding hole 112, the two prongs 140 thereby holding the inner ring 130 and conditioner pad 120 in place (see FIG. 1). It can also be seen from the FIG. 1 that mounting ring 1 10 preferably includes two diametrically opposed depressions 145 formed in the inner surface thereof which facilitate assembly of the inner ring 130 and conditioner pad 120 into the mounting ring 110. These depressions are by no means required, however.

In an alternate embodiment, the prongs could be replaced by springs or another type of support structure.

FIG. 4 shows an alternate embodiment whereby the conditioner pad 120 and inner ring 130 are attached to the assembly mounting structure 110 by a single prong 140.

The assembly mounting structure, prong, and conditioner pad/inner ring can be constructed and arranged in any manner that allows the conditioner pad to rotate about the longitudinal axis of the prong.

As shown in FIGS. 2 and 3, the inner ring 130 optionally includes one, and more preferably two, wings 150 that protrude axially from opposite sides of the planar surface of the inner ring 130 at diametrically opposed edges of the ring 130. Each wing 150 projects from a portion of the periphery of the ring 130 and has an axial extent that begins at zero at a location adjacent the axis of rotation (i.e., near prong 140) and increases gradually to a maximum extent at a position 90 degrees from the prongs 140 and then decreases gradually to zero adjacent the axis of rotation. The wings 150 facilitate rotation of the conditioner pad when it is exposed to the air stream of the hair dryer. The wings 150 are illustrated and described herein, although it will be apparent that they are not required in order to cause the conditioner pad to rotate when exposed to the air stream of the hair dryer.

The mounting ring 110 is constructed and arranged to conform to the interior surface of whatever apparatus (e.g., the barrel of a blow dryer or a nozzle attachment) into which it is inserted. When the-interior surface of the apparatus is circular, the inner and mounting rings are also preferably circular. It will be appreciated, however, that the mounting ring 110 and inner ring 130 are not limited to circular rings. Moreover, the conditioner applicator element—comprising, in the illustrated embodiment, inner ring 130 and disc-shaped conditioner pad 120—need not be essentially flat, but may be any shape (e.g., spherical) that will efficiently rotate when exposed to the air stream generated by the hair dryer.

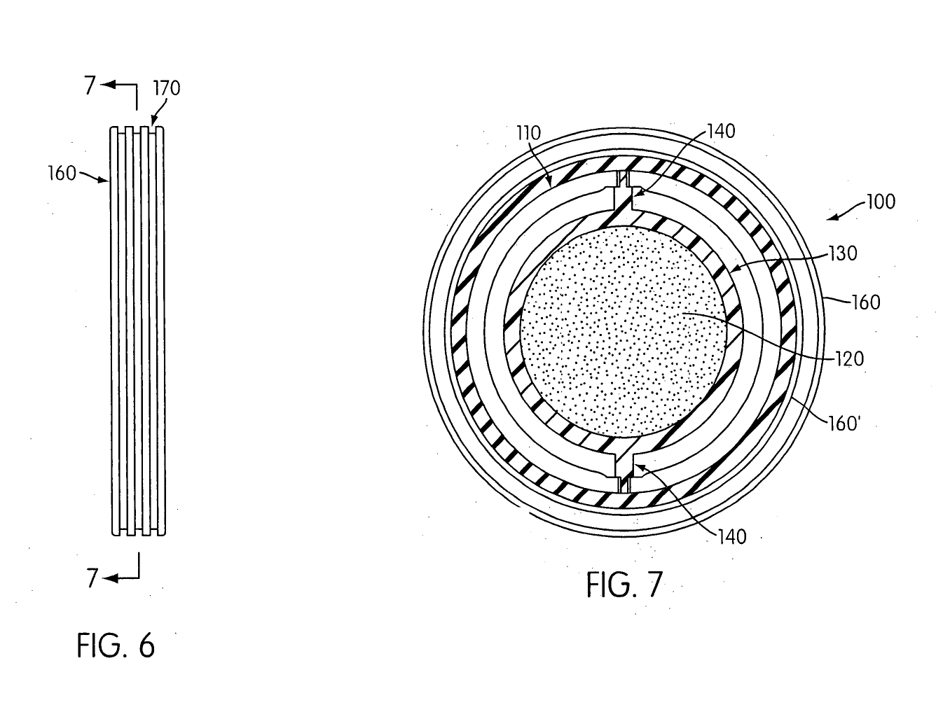

The assembly mounting structure optionally also includes at least one spacer ring 160, illustrated in FIGS. 5-7. Spacer ring 160 is formed of a resilient material and is stretched over the outer circumference of the mounting ring 110. More than one spacer ring may be used, with each additional spacer ring being stretched over the circumference of the previous spacer ring. The number of spacer rings used in the assembly mounting structure depends upon: (1) the size of the interior surface of the apparatus into which the assembly mounting structure is inserted; and (2) the size of the mounting ring. For a selected mounting ring size, one, two or more spacer rings 160 may be used in order to properly fit the mounting ring 110 in the apparatus. Additional spacer rings would be of progressively increasing size. Each spacer ring 160 is preferably constructed of a resilient, high friction material, and is preferably formed from plastic, rubber or silicone. The single spacer ring illustrated in FIGS. 5 and 6 is circular in shape, but could be any shape that conforms to the inside surface of whatever apparatus into which it is to be inserted.

Spacer ring 160 also preferably has a ribbed outer edge 170 (see FIG. 6) comprising a plurality of continuous ribs projecting radially from the outer circumference of the ring. The ribbed outer edge 170 is constructed and adapted to provide a suitable surface for deforming and frictionally engaging the interior surface of the apparatus into which the conditioner application assembly 100 is inserted. Each spacer ring 160 also preferably has a recessed inner portion 180, which is constructed and adapted to allow a smaller spacer ring or the mounting ring 110 to fit inside, thereby firmly supporting the smaller spacer ring or mounting ring 130. FIG. 7 is a cross-sectional view of the conditioner applicator assembly 100, showing two spacer rings 160, 160′ installed over a mounting ring 110 and an inner ring 130/conditioner pad 120.

As described above, the conditioner pad 120 is preferably sized to be as large as possible in order to allow more hair treatment product to be applied thereon. The conditioner pad should not be so large, however, that it unduly restricts the flow of air from the hair dryer, which could cause the hair dryer to overheat. It has been found that when the conditioner pad 120 and inner ring 130 is about 75-95% of the size of the mounting ring 110, the conditioner pad is sufficiently large and air flow from the hair dryer is not overly restricted. More preferably, the conditioner pad and inner ring 130 is about 85-90% of the size of the mounting ring 110. In the illustrated embodiment, with a circular mounting ring 110 and circular inner ring 130/conditioner pad 120, the respective “sizes” are the inner diameter of the mounting ring 110 and the outer diameter of the inner ring 130.

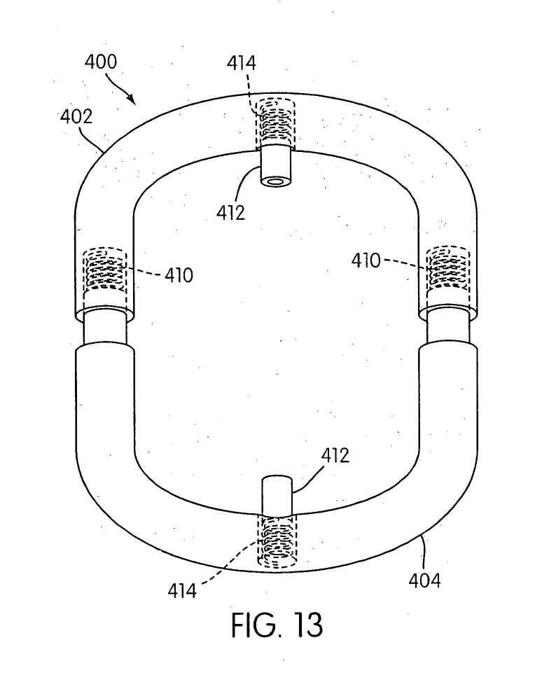

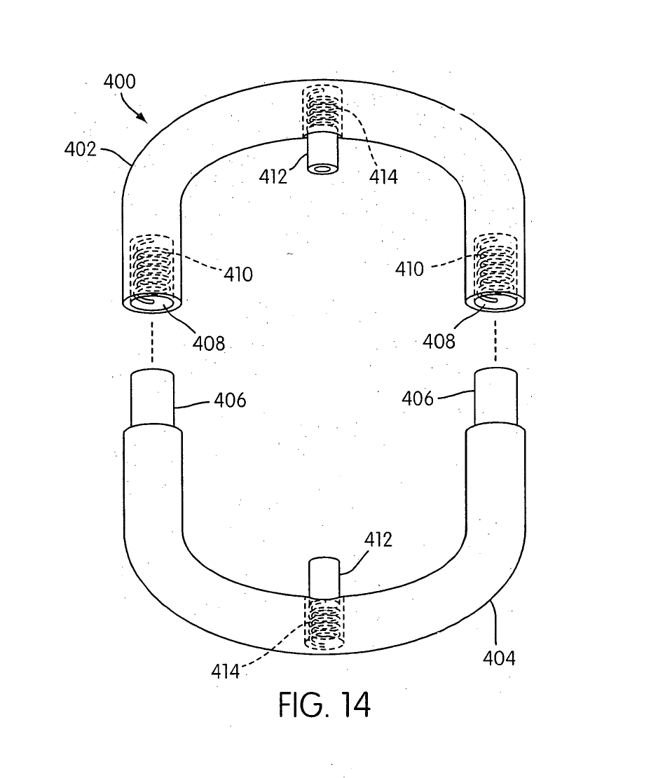

In an alternate embodiment, illustrated in FIGS. 13 and 14, the assembly mounting structure is of a two-piece ring construction 400. The two pieces 402, 404 are constructed and arranged so that they can be placed together to form a shape that conforms to the inner surface of the apparatus into which the assembly mounting structure is to be inserted. In a preferred embodiment, each end of one of the pieces 404 has a “male” end 406, and each end of the other piece 402 has a “female” end 408. The male and female ends are sized so that the male ends fit into the female ends, forming a continuous assembly mounting structure. Each female end 408 alternatively contains a spring 410. The springs function to help frictionally hold the conditioner applicator assembly in the apparatus. When the two pieces of the conditioner applicator assembly are joined together and the assembly is inserted in the apparatus, the springs will be slightly compressed. This slight compression will assist in frictionally holding the assembly in the apparatus. Ring 400 includes prongs 412 biased inwardly by springs 414 for rotatably mounting a conditioner application element (not shown).

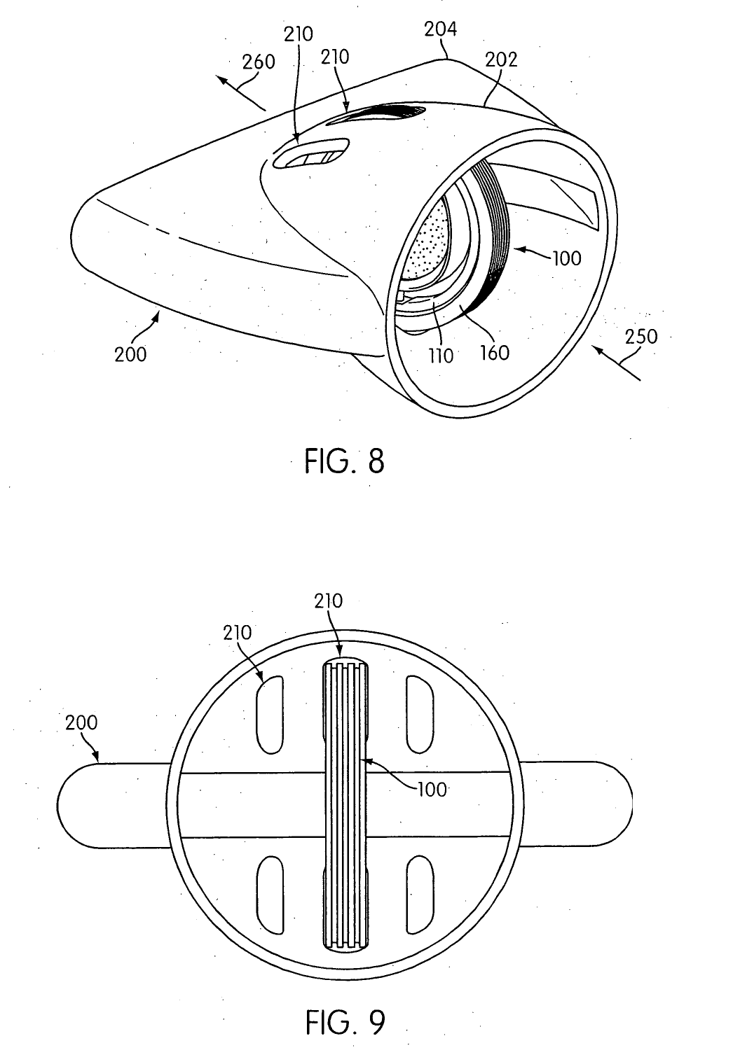

As illustrated in the embodiments of FIGS. 8-12, the assembly mounting structure (i.e., mounting ring 110 and, optionally, spacer ring(s) 160) is constructed and arranged to secure the conditioner applicator assembly 100 within a nozzle attachment to a hair dryer. The nozzle attachment can be any apparatus configured to be attached to a hair dryer, such as an air concentrator, a diffuser, or a straight nozzle attachment. Alternatively, in certain embodiments the conditioner applicator assembly can be constructed and arranged to be inserted directly into the hair dryer, without using a nozzle attachment. The assembly mounting structure can be supported in the nozzle attachment or hair dryer either: (1) frictionally, with a mounting ring 110 and/or spacer ring(s) 160 as described above; or (2) by a rigid structure, such as an opening in the hair dryer or nozzle attachment, that securely holds the assembly mounting structure in place.

FIGS. 8-11 illustrate two of the many possible configurations for supporting a conditioner applicator assembly 100 in a nozzle attachment, the nozzle attachment in the figure being an air concentrator 200. The air concentrator 200 is a typical air concentrator with air vents 210, an air inlet end 250, and an air outlet end 260. Other air concentrators or types of nozzle attachments could have different designs and features; any configuration that rotatably supports a conditioner pad and allows the conditioner pad to rotate when exposed to the air stream of a hair dryer can be used.

In a preferred embodiment, FIGS. 8 and 9 illustrate a conditioner applicator assembly inserted into the concentrator 200 so that an edge of the conditioner applicator assembly 100 faces the air inlet end 250 of the hair dryer (not shown in the figure), and thus the plane of the mounting ring 110 is oriented so as to be generally parallel with the direction of the air flow. The concentrator 200 includes a generally conical portion 202 which merges into a narrowed and widened portion 204. Air vents 210, extending in a generally longitudinal direction relative to the air flow, are formed in the lower, narrow portion of the conical portion 202. A vent 210 is provided in the transverse center of the concentrator 200 and has a width that is slightly larger than the axial thickness of the mounting ring 110 and spacer ring 160. The outer diameter of the mounting ring 110/spacer ring 160 subassembly is such that the conditioner applicator assembly 100 can be inserted into the lower end of the conical portion 202 with portions of the mounting ring 110/spacer ring 160 subassembly projecting from diametrically opposed vents to secure the conditioner applicator assembly 100 within the concentrator 200 when the concentrator 200 is installed onto the hair dryer.

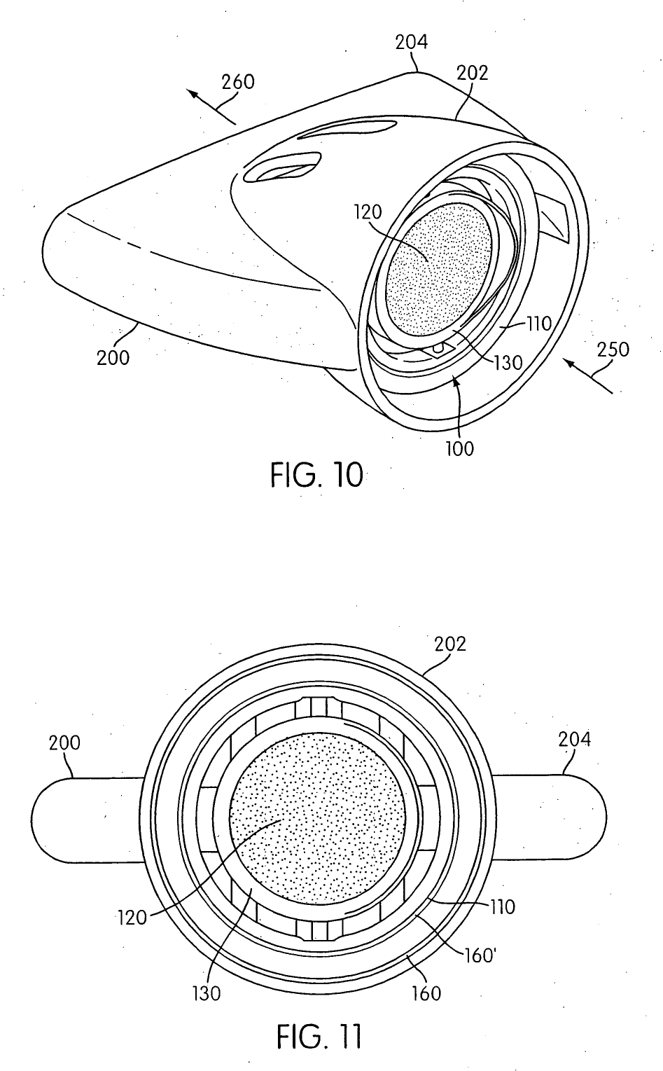

In an alternate embodiment, FIGS. 10 and 11 illustrate a conditioner applicator assembly inserted into the nozzle attachment so that the plane of the mounting ring 110 is oriented so as to be generally perpendicular to the direction of the air flow. The applicator assembly 100 is held in place by the frictional engagement caused by wedging the applicator into the conical portion 202 of the concentrator 200, thereby deforming the spacer rings 160, 160′.

In each of these configurations, the conditioner pad, supported by the conditioner applicator assembly, rotates about an axis that is transverse to the direction of the air stream.

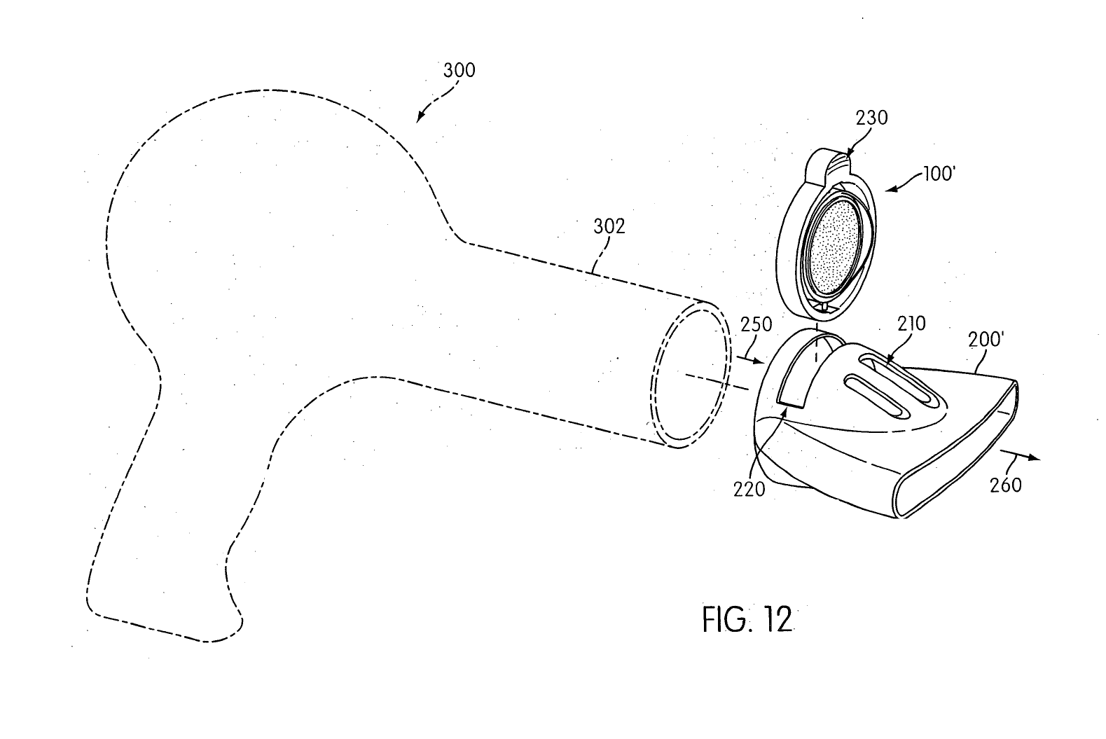

FIG. 12 illustrates another embodiment in which the conditioner applicator assembly 100′ is constructed and arranged to be inserted into a transverse slot opening 220 formed in the nozzle attachment (concentrator 200′). When the conditioner applicator assembly 100′ is inserted into the opening 220, the conditioner applicator assembly 100′ is rigidly supported inside the nozzle attachment. In an alternate embodiment (not illustrated), the conditioner applicator assembly can be inserted into a transverse slot opening formed in the barrel 302 of the hair dryer 300, without the need for a nozzle attachment. The conditioner applicator assembly 100′ can optionally have a protrusion such as a handle 230 or other suitable feature to facilitate insertion and removal of the conditioner applicator assembly 100′ from the opening 220 in the nozzle attachment or hair dryer.

The foregoing has described the principles, embodiments, and modes of operation of the invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

1. A conditioner applicator assembly adapted to be mounted within an air stream of a hair dryer, the assembly comprising:
an assembly mounting structure constructed and arranged to mount the assembly relative to a portion of the hair dryer; and
a conditioner applicator element rotatably supported by said assembly mounting structure and constructed and arranged to rotate when exposed to the air stream of the hair dryer.

2. The conditioner applicator assembly of claim 1, wherein said conditioner applicator element is constructed and arranged to rotate about an axis that is transverse to the direction of the air stream.

3. The conditioner applicator assembly of claim 1, wherein said assembly mounting structure is constructed and arranged to secure the assembly within a nozzle attachment to the hair dryer.

4. The conditioner applicator assembly of claim 1, wherein said assembly mounting structure comprises a mounting ring.

5. The conditioner applicator assembly of claim 4, wherein said mounting ring is constructed and arranged to be inserted into a nozzle attachment to the hair dryer and frictionally engage a portion of an inner surface of the nozzle attachment to frictionally hold the assembly within the nozzle attachment.

6. The conditioner applicator assembly of claim 4, wherein said mounting ring is constructed and arranged to be inserted into the hair dryer and frictionally engage a portion of an inner surface of the hair dryer to frictionally hold the assembly within the hair dryer.

7. The conditioner applicator assembly of claim 4, wherein said conditioner applicator element comprises:
an absorbent conditioner pad;
an inner ring supporting a periphery of said conditioner pad; and
at least one mounting prong for rotatably mounting said inner ring within said mounting ring.

8. The conditioner applicator assembly of claim 4, wherein said mounting ring is constructed and arranged to be inserted into an opening formed in the hair dryer or in a nozzle attachment for the hair dryer.

9. The conditioner applicator assembly of claim 8, wherein said opening is oriented either generally parallel or transverse to the direction of air flow throw the hair dryer or nozzle attachment.

10. The conditioner applicator assembly of claim 7, wherein said mounting ring, said conditioner pad, and said inner ring are circular in shape.

11. The conditioner applicator assembly of claim 7, wherein said inner and mounting rings are independently formed from metal, ceramic, PBT, ABS, polypropylene, or other plastic.

12. The conditioner applicator assembly of claim 4, wherein said assembly mounting structure further comprises at least one spacer ring, said at least one spacer ring conforming to an inner surface of the hair dryer or a nozzle attachment to the hair dryer, and said spacer ring conforming to an outer surface of said mounting ring.

13. The conditioner applicator assembly of claim 12, wherein said at least one spacer ring is formed from plastic, rubber or silicone.

14. The conditioner applicator assembly of claim 7, wherein said conditioner pad is formed from polyester, cotton, a blend of polyester or cotton, natural or synthetic sponge, wood, wood pulp, cellulose or ceramic.

15. The conditioner applicator assembly of claim 7, wherein said conditioner pad further comprises at least one wing, said at least one wing constructed and arranged to facilitate rotation of said conditioner pad when exposed to the air stream of the hair dryer.

16. A conditioner applicator assembly comprising a conditioner applicator element adapted to be rotatably supported within an air stream of a hair dryer and constructed and arranged to rotate when exposed to the air stream.

17. The conditioner applicator assembly of claim 16, wherein said conditioner applicator element comprises a conditioner pad formed from polyester, cotton, a blend of polyester or cotton, natural or synthetic sponge, wood, wood pulp, cellulose or ceramic.

18. The conditioner applicator assembly of claim 16, further comprising an assembly mounting structure constructed and arranged to rotationally support said conditioner applicator element in the air stream of the hair dryer, wherein the assembly mounting structure is formed from metal, ceramic, PBT, ABS, polypropylene, or other plastic.

19. The conditioner applicator assembly of claim 16, wherein said conditioner applicator element comprises:
an absorbent conditioner pad;
a ring supporting a periphery of said conditioner pad;
at least one mounting prong for rotatably mounting said ring within the air stream; and
at least one wing projecting from said ring, said at least one wing constructed and arranged to facilitate rotation of said conditioner pad when exposed to the air stream of the hair dryer.

20. The conditioner applicator assembly of claim 19, wherein said absorbent pad, and said ring are circular in shape.

21. A hair dryer comprising:
a housing including an air exhaust port;
a rotatable conditioner applicator element positioned relative to the air exhaust port to rotate when exposed to an airstream from the air exhaust port.

22. A conditioner applicator assembly adapted to be mounted within an air stream of a hair dryer, the assembly comprising:
assembly mounting means for mounting the assembly relative to a portion of the hair dryer; and
conditioner applicator means rotatably supported by said assembly mounting means for rotating when exposed to the air stream of the hair dryer.
